(19) United States
(12) Patent Application Publication
(10) Pub. No.: US 2010/0076597 A1
(43) Pub. Date: Mar. 25, 2010

(54) STORYTELLING ROBOT ASSOCIATED WITH ACTIONS AND METHOD THEREFOR

(75) Inventors: CHUAN-HONG WANG, Tu-Cheng (TW); LI-ZHANG HUANG, Tu-Cheng (TW); HSIAO-CHUNG CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/426,932

(22) Filed: Apr. 20, 2009

(30) Foreign Application Priority Data
Sep. 25, 2008 (CN) 200810304674.5

(51) Int. Cl. G06F 19/00

(52) U.S. Cl. 700/245

(57) ABSTRACT

The present invention relates to a storytelling robot associated with actions and a method adapted for the robot. The robot stores actions, first relationships between the actions and key information, second relationships between the key information and audio data, and audio data associated with the audio stories. The method includes: a) beginning performing an action; b) fetching key information according to the action; c) fetching audio data according to the key information; and d) outputting a story corresponding to the audio data.

### BACKGROUND

1. Technical Field

The disclosure relates to a robot and, more particularly, to a storytelling robot associated with actions and a method adapted for the robot.

2. Description of the Related Art

There are many electronic toys that play audio books, and there are many robots for entertainment that can perform various actions. What is needed though, is a robot that can act according to the contents of the stories as they are played.

### BRIEF DESCRIPTION OF THE DRAWINGS

The components in the drawings are not necessarily drawn to scale, the emphasis instead being placed upon clearly illustrating the principles of the robot. Moreover, in the drawings, like reference numerals designate corresponding parts throughout the several views.

FIG. 1 is a block diagram of a hardware infrastructure of a storytelling robot associated with actions in accordance with an exemplary embodiment.

FIG. 2 is an example of an information action table of the robot of FIG. 1.

FIG. 3 is an example of a story information table of the robot of FIG. 1.

FIG. 4 is a flowchart illustrating a method of telling stories associated with actions implemented by the robot of FIG. 1.

### DETAILED DESCRIPTION

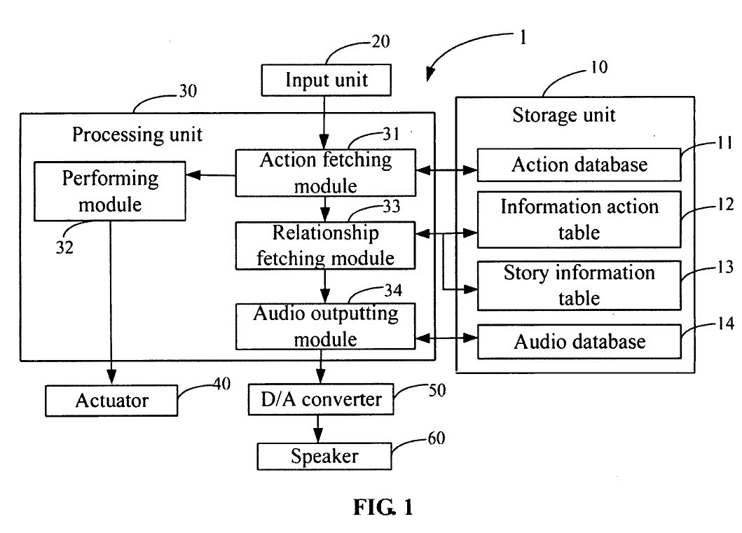

FIG. 1 is a block diagram of a hardware infrastructure of a storytelling robot 1 associated with actions in accordance with an exemplary embodiment. The robot 1 includes a storage unit 10, an input unit 20, a processing unit 30, an actuator 40, a digital-to-analog (D/A) converter 50, and a speaker 60. The storage unit 10 stores an action database 11, an information action table 12, a story information table 13, and an audio database 14. The action database 11 stores a list of actions that can be performed by the robot 1.

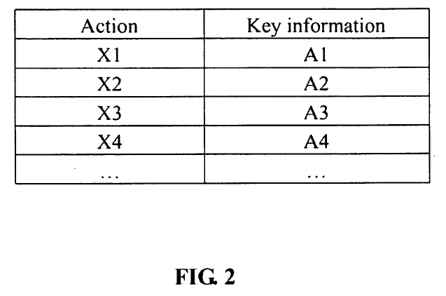

FIG. 2 is an example of the information action table 12 of the robot of FIG. 1. The information action table 12 shows that each action performed by the robot 1 is associated with key information. The key information is selected from the group consisting of words, phrases, and a combination of words and phrases. The information action table 12 stores relationships between actions and key information, and includes an action column, and a key information column. The action column records a plurality of actions to be performed by the robot 1, such as a “salute” action “X1”, a “sit down” action “X2”, and the like. The key information column records a plurality of key information associated with the actions, such as a key word of salute “A1”, a key phrase of sit down “A2”, and the like.

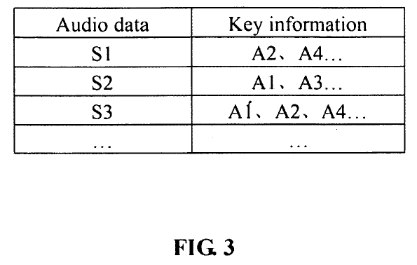

FIG. 3 is an example of the story information table 13 of the robot of FIG. 1. The story information table 13 stores relationships between the key information and audio data associated with audio stories, and includes a key information column, and an audio data column. The key information column records a plurality of key information associated with the audio data. For example, the key information of the audio data “S1” includes “A2” and “A4”. The audio data column records a plurality of audio data associated with audio stories. The audio database 14 stores a list of audio data.

The input unit 20 is configured for generating instructions in response to user input. The processing unit 30 further includes an action fetching module 31, a performing module 32, a relationship fetching module 33, and an audio outputting module 34. The action fetching module 31 is configured for fetching an action from the action database 11 according to an instruction generated from the input unit 20 when a user inputs an action request. The performing module 32 is configured for controlling the actuator 40 to perform the action. The actuator 40 performs the action via moving parts of the robot 1.

The relationship fetching module 33 is configured for fetching the key information from the information action table 12 according to the fetched action, and fetching audio data from the story information table 13 according to the fetched key information. In this embodiment, the audio data and the key information could have many to many relationships, and the relationship fetching module 33 fetches audio data associated with the key information randomly from the story information table 13. The audio outputting module 34 is configured for fetching the audio data from the audio database 14 and outputting the audio data. The D/A converter 50 is configured for converting the audio data into analog data. The speaker 60 outputs analog data as a story. In other words, a user selects and inputs an action, and then the robot 1 begins performing the action while accessing and playing a story associated with the action. If the story has other key information and action associations, those actions will also be performed during the course of the story.

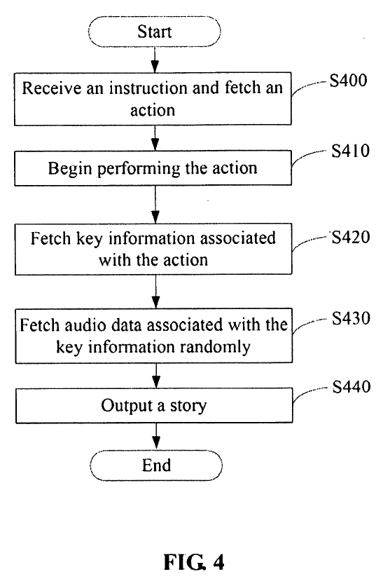

FIG. 4 is a flowchart illustrating a method of telling stories associated with actions implemented by the robot of FIG. 1. In step S400, the action fetching module 31 receives the instruction generated from the input unit 20 and fetches the action from the action database 11. In step S410, the performing module 32 controls the actuator 40 to begin performing the action. In step S420, the relationship fetching module 33 fetches the key information according to the fetched action from the information action table 12. In step S430, the relationship fetching module 33 further fetches the audio data according to the fetched key information from the story information table 13 randomly, and the audio outputting module 34 fetches the audio data from the audio database 14 and outputs the audio data. In step S440, the D/A converter 50 converts the audio data into analog data, and the speaker 60 outputs the story.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A storytelling robot associated with actions, comprising:
a storage unit, configured for storing actions, first relationships between the actions and key information, second relationships between the key information and audio data, and audio data associated with stories;
an actuator, configured for performing an action;
a relationship fetching module, configured for fetching key information according to the action from the storage unit, and fetching audio data according to the fetched key information from the storage unit; and
a speaker, configured for outputting a story.

2. The storytelling robot as recited in claim 1, further comprising an input unit, configured for generating instructions for determining the action to be performed in response to user input.

3. The storytelling robot as recited in claim 2, further comprising an action fetching module, configured for fetching the action from the storage unit according to an instruction from the input unit.

4. The storytelling robot as recited in claim 3, further comprising a performing module, configured for controlling the actuator to begin performing the action.

5. The storytelling robot as recited in claim 1, further comprising an audio outputting module, configured for fetching the audio data from the storage unit and outputting the audio data.

6. The storytelling robot as recited in claim 5, further comprising a digital-to-analog converter, configured for converting the audio data into analog data as a story.

7. The storytelling robot as recited in claim 1, wherein the key information is selected from the group consisting of words, phrases, and a combination of words and phrases.

8. The storytelling robot as recited in claim 1, wherein the relationship fetching module fetches the audio data according to the key information randomly from the storage unit.

9. A method for a storytelling robot associated with actions, wherein the robot stores actions, first relationships between the actions and key information, second relationships between the key information and audio data, and audio data associated with the stories, the method comprising:
beginning performing an action;
fetching key information according to the action;
fetching audio data according to the key information; and
outputting a story corresponding to the audio data.

10. The method as recited in claim 9, further comprising:
receiving an instruction and fetching the action.

11. The method as recited in claim 9, further comprising:
fetching the audio data according to the key information randomly and outputting the audio data.

12. The method as recited in claim 11, further comprising:
converting the audio data into analog data as a story.

13. The method as recited in claim 9, wherein the key information is selected from the group consisting of words, phrases, and a combination of words and phrases.
